(19) United States
(12) Patent Application Publication
(10) Pub. No.: US 2009/0278975 A1
(43) Pub. Date: Nov. 12, 2009

(54) Method of correcting perspective deformation of a lens system

(76) Inventor: Detlef GROSSPIETSCH, Odenthal (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/134,499

(22) Filed: Jun. 6, 2008

(30) Foreign Application Priority Data
Sep. 25, 2007 (EP) 07018860.2

(51) Int. Cl. G02B 13/16

(52) U.S. Cl. 348/335; 348/E05.024

(57) ABSTRACT

The present invention relates to a method for the correction of perspective deformation in a lens system (1) in which image data, which describe an image projected through the lens system, are corrected with correction values and the image data corrected in this way are output for the display of a corrected image. A correction of the perspective deformation is obtained with the present invention in a simple manner in that the angular position of the lens system (1) on producing the image data acquires reproducing angular position data, a record of angular position correction data, which match the angular position data, are read out of a data base, in which a large number of data records have been saved for different angular positions of the lens system (1), and the image data are corrected with the determined angular position correction data.

The present invention relates to a method for the correction of perspective deformation in a lens system in which image data, which describe an image projected through the lens system, are corrected with correction data and the image data corrected in this way are output for the display of a corrected image.

A method of this nature is for example known from EP 1 295 469 which comprises a digital camera or a video camera with an object lens, a sensor for the acquisition and digitisation of the complete image information formed by the object lens and contained in an image circuit as well as means for storing the digitised image information. Furthermore, the digital camera has a tilt position sensor. The sensor for the acquisition and digitisation of the complete information imaged by the object lens and contained in an image circuit is pivotably supported and can be aligned to the horizontal in accordance with the tilt position measured by the tilt position sensor. In an alternative suggested solution the image information can be rotated to the horizontal in accordance with the tilt position measured by the tilt position sensor.

Consequently, the known suggested solution discloses nothing other than a digitised view camera. With view cameras of this nature, which have always been known as conventional view cameras, the problem of a perspective deformation is countered with view, shift or tilt object lenses, which facilitate a certain correction of perspective deformation. However, the construction of view cameras is complex so that they are cost-intensive. Moreover, substantial experience is required to compensate perspective deformation by appropriate adjustment of the view camera.

The above-mentioned classifying state of the art counters this problem in that the optical deformation caused by the tilt position of the camera is acquired by the tilt position sensor and the sensor for the acquisition and digitisation of the image information is changed in its alignment in the camera for the correction of perspective errors. In other words the suggested solution according to EP 1 295 469 utilises the approach, sufficiently well known with conventional (analogue) cameras, of compensating optical deformation by relative movement between the plane of the object lens and the imaging plane.

The suggested solution according to this state of the art requires a special camera which is provided with a special drive for adjusting the sensor for acquiring the image information. Consequently, the camera is complicated to manufacture and relatively prone to faults due to the mechanical components.

The object of the present invention is to specify a method of correcting perspective deformation of a lens system, which with little expense in terms of apparatus for the camera can be reliably realised and which does not require any special knowledge on the part of the photographer. The method should be able to be easily realised with conventional digital cameras.

This object is solved according to the present invention by a method with the characteristics of claim 1.

Preferred further developments are given in the dependent claims.

With the method according to the invention the angular position of the lens system is acquired when the image data is produced and in fact in the form of angular position data. These angular position data are read out from the camera and in fact either directly or after intermediate storage on a storage medium in the camera. This can for example have various memories for saving the image data acquired by the sensor for acquisition of the image information, whereas a separate memory saves the angular position data. Preferably, time information is saved for both data records, so that the two data records can be assigned to one another by comparing the time information when they are read out of the camera or at a later time. In any case an angular position data record is assigned or can be assigned to the image data record. The correction of the optical deformation occurs based on these data. Here, according to the invention a data base is accessed in which angular position correction data are saved. The data base normally contains a large number of correction data for different angular positions. Based on the angular position data assigned to a particular image, i.e. to an image data record, the angular position correction data matching the angular position on imaging the image data are selected from the data base from where they are read out. A central computer is preferably directly assigned to the data base, which converts the image data based on the angular position correction data and thus corrects the optical deformation. This correction normally occurs through a pixel-to-pixel correction. Here, methods can be used with which the computer performance can be reduced. For example, optical axes of symmetry can be used to mirror calculated correction data. The corrected image data determined in the central computer are finally output to display a corrected image of the imaged object. This display can be produced on a monitor or however on a medium, for example photographic paper, by printing the corrected image data.

With the present invention conventional digital cameras only need to be fitted or retrofitted with sensors for determining the angular position. Sensors of this nature can for example be formed by a spirit level, in particular an electronic spirit level, which displays the tilt position of the camera relative to the horizontal.

“Electronic spirit level” is taken to mean any sensor which due to the earth's gravitational force can indicate a tilt position of an object joined to the electronic spirit level relative to the line of influence of the earth's gravitational force.

Just as well, acceleration sensors can be provided on the camera, which acquire the tilt position of the camera. Also, various sensors can be combined together and built into or onto the camera.

With a tilt position of the optical axis relative to the horizontal plane, in particular an electronic spirit level is used. A corresponding situation applies to the tilt position relative to the horizontal and about an axis which extends at right angles to the optical axis of the optical system.

With the method according to the invention preferably also restitution of perspective errors occurs which arise when the optical system is swivelled about a vertical axis. For the correction of deformation of this nature preferably the optical system is arranged with its optical axis at right angles to a flat plane of an object to be imaged and then calibrated. The completed rotation of the optical system about the vertical for transferring the optical system from this calibration position into the position which is assumed on producing the image, i.e. the image data, is determined by at least one sensor fitted to the optical system, which is normally an acceleration sensor. With this further development the user of the optical system must accordingly indicate to the camera that the calibration position has been taken up. After an appropriate signal the optical system preferably records the actuation of the release, i.e. the acquisition of image data directly after the calibration, as an indication that the rotation about the vertical, which occurred between the calibration and the release and has been measured by the at least one sensor, should be saved as angular position information for the corresponding rotation about the vertical.

With the method according to the invention a data base is used in which angular position correction data are saved. These angular position correction data involve in particular correction data, which are produced based on a comparison of imaging data from a test chart with correction image data, which have been produced by imaging the test chart with an angular offset with respect to a central perspective axial position relative to the test chart. In other words the angular position correction data have been determined by exposing a test chart via an imaging system with an angular offset of the optical axis of the imaging system relative to the central perspective axis on the test chart and comparing the image data of the image thus obtained with the imaging data for the production of the test chart. The data base preferably has records of angular position correction data produced for all conceivable angular deviations from the central perspective axial position. Preferably, for each conceivable alignment of a recording system, for example a digital camera, a corresponding record of angular position correction data is saved in the memory relative to the verticals or horizontals at the recording location. Furthermore, preferably these data records can be determined for various object lenses and/or optical systems (e.g. cameras) through measurement and saved in the data base. Here, it is conceivable to save the aforementioned positional deviations, i.e. the deviation of the optical axis of the camera from the horizontal plane and the deviation between the camera horizontal and the genuine horizontal, themselves in each case in the data base or to save records of angular position correction data which already take into account the overlapping of the two deviations.

To realise the method according to the invention preferably a processor is used which can be connected to the memory, which stores the image data, and the data base in order to read out on one hand the image data and the angular position data from the memory and on the other hand to read out the angular position correction data from the data base. Here, the processor is prepared such that initially and preferably, based on the definitive angular position data for the optically deformed image from the data base, it reads out certain angular position correction data which have been saved for an angular positional deviation which most closely approximates the existing angular deviation on producing the image. Only with these certain angular position correction data, i.e. the certain record of angular position correction data from the data base, a mathematical correction of the image data is carried out. Preferably, the record of angular position correction data determinable by the angular position data found is automatically selected by the processor, but in any case when only an automated, best possible correction of the perspective deformation is to be achieved with the recording system according to the invention. However, it is particularly conceivable in the field of professional photography that based on angular position correction data certain perspective deformation effects are to be emphasised and artistically highlighted. In this case the desired record of angular position correction data can also be determined individually and read out.

The suitable record of angular position correction data is used for the conversion of the image data saved in the memory in order to calculate corrected image data. These corrected image data are used to produce an image which is changed with respect to its perspective deformation. Normally, this signifies that the changed image does not have any or only negligible perspective deformation. In this case, automatically corrected image data can be produced for very different angular positions of the camera when producing the image.

It has been found to be advantageous if records of angular position correction data are saved in the data base which have an angular offset of no more than two degrees, preferably of no more than one degree relative to one another. With this specification a relatively close grid of angular steps of one degree or two degrees can be saved in the data base, facilitating a very accurate correction of perspective deformation in all conceivable positional deviations of the camera with regard to a co-ordinate system containing the verticals and horizontals. With the method according to the invention at least one correction of optical deformations occurs in a plane, i.e. a restitution for optical deformations which arise in that the camera is swivelled with its optical axis or an axis extending at right angles to it and with perpendicular camera alignment in the axis running horizontally. Angular positions of this nature can be acquired with the electronic spirit level.

A restitution preferably occurs in two planes, wherein in addition to the aforementioned swivel movements of the camera, also the swivel movement about the vertical axis is determined for the correction of optical deformation. For the restitution in two planes, according to a preferred development of the present invention, the angular position correction data are read out of a data base in which conceivable angular positions of the optical system during production of an image about three axes of a Cartesian co-ordinate system are in each case saved at intervals which preferably have an identical interval width for each of the three axes and preferably lie between 0.5 and 2°.

According to a preferred embodiment of the present invention, the recording system has a possibility of correcting optical distortions of the lens system. These optical errors in particular include the vignetting and distortion, i.e. shadowing of the image at the edge of the image and the curving of straight lines by the lens, which in the photographical image appear, for example, barrel or cushion-shaped. Accordingly, during the production of the image, along with the angular position data, also data on the object lens used for producing the image are saved. In the data base preferably the optical errors of a large number of different object lenses are saved.

Accordingly, lens-specific correction data are held in the data base and the processor provided for realising the method is prepared such that the image data are converted initially for the production of optically corrected image data, which have been purged of optical errors due to the lens system and these optically corrected image data are then converted into the aforementioned perspectively corrected image data. In other words, based on the correction data in the data base, the distortion is for example calculated out and then the optical deformation. The optically corrected image data continue to give a perspectively deformed image, but have been purged of lens errors, in particular the distortion. The perspectively corrected image data calculated based on these optically corrected image data have been corrected with regard to the optical errors in the lens system as well as with regard to the perspective deformation. The image which can be produced with the corrected image data displays no artefacts.

One method of correcting the distortion, which can be used within the scope of the present invention, is for example known from DE 101 26 546.

To reduce the computational power for the operator of the data base, according to a preferred further development of the invention it is suggested that after transfer of the angular position data and data, which are assigned to the optical system and for example identify or return the object lens used, the recording format, the focal length and/or aperture during the recording, the angular position correction data found from the data base is read out and sent to the sender so that the correction of the image data by the sender can take place.

The data base can also be used in order to read out angular position correction data according to the individual requirements of a user, based on which the user can correct or modify any desired image data in order to achieve special perspective effects. In other words the actual correction data can be used to exert a design influence on the perspective. The exertion of this influence takes place via the imaging plane according to a type of “virtual standard”.

An embodiment will now be discussed in the following in conjunction with the drawing to explain the present invention and its effect. This shows the following:

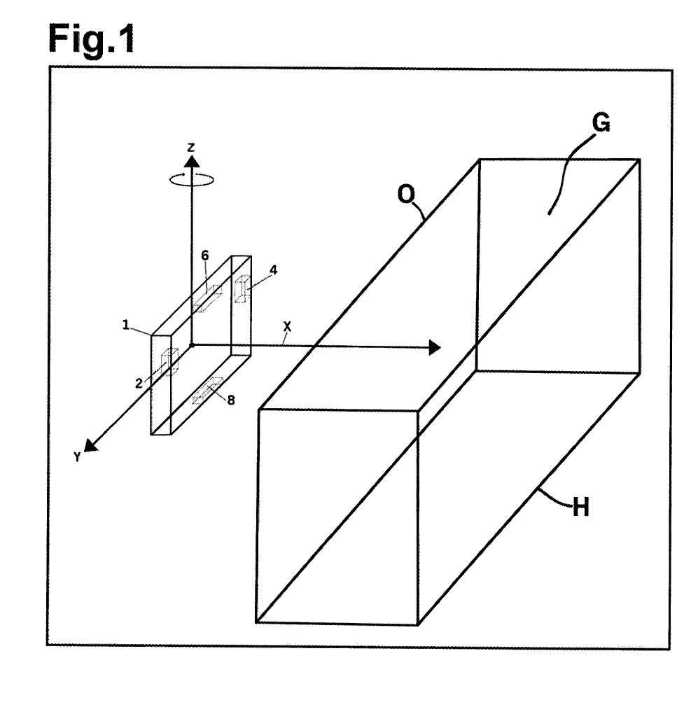

FIG. 1 a schematic illustration of a camera and its arrangement relative to a rectangular object standing upright;

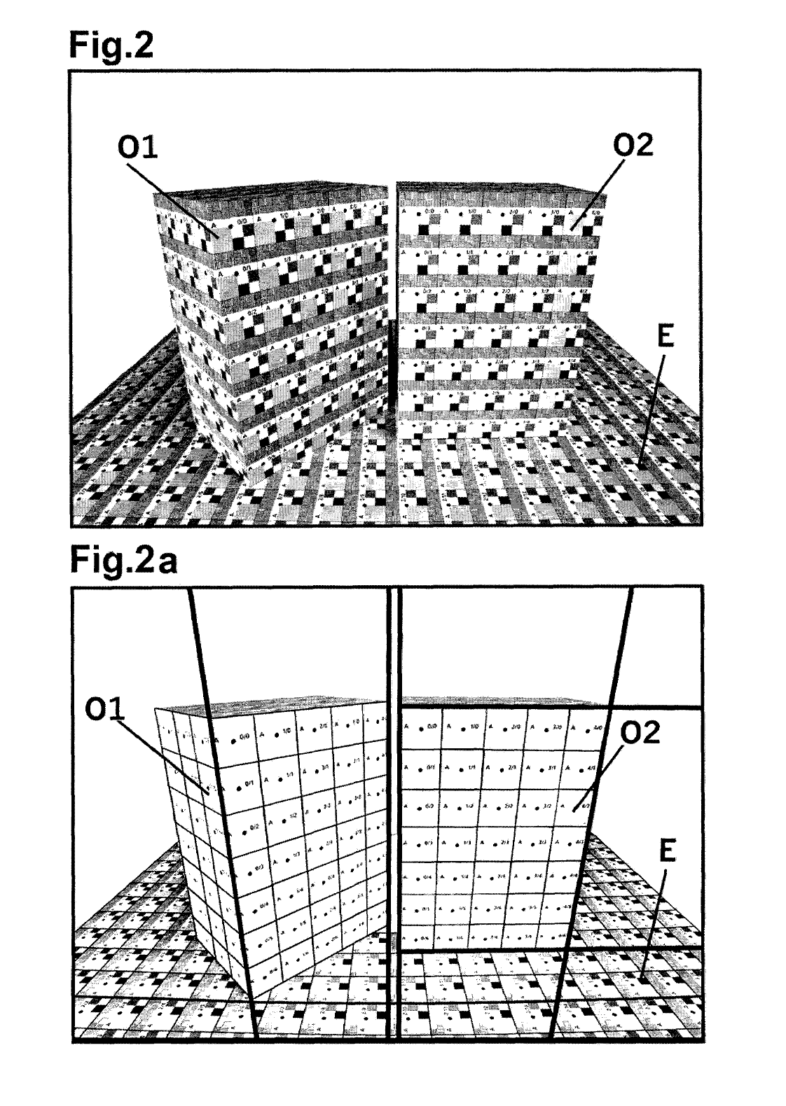

FIG. 2/2a the image of an arrangement provided with test charts of two objects standing upright on one plane, arranged at an angle to one another with a perspective modification of camera 1 in one plane without the correction according to the invention;

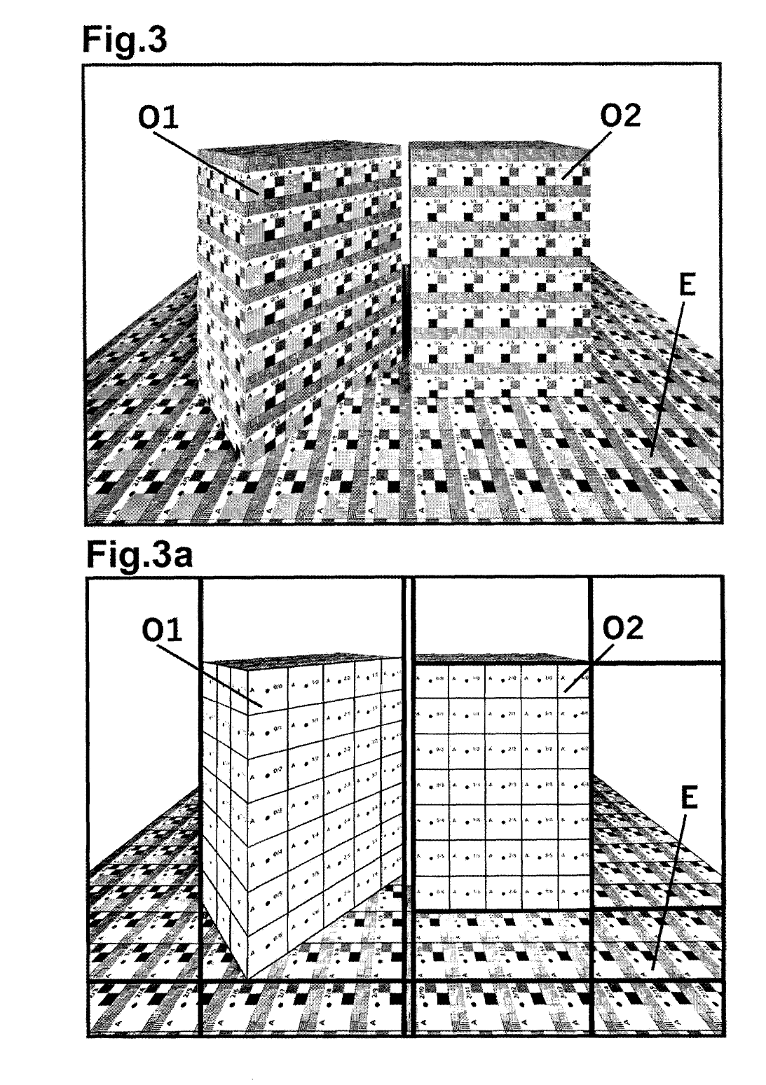

FIG. 3/3a the illustration shown in FIG. 2/2a after correction with the correction method according to the invention;

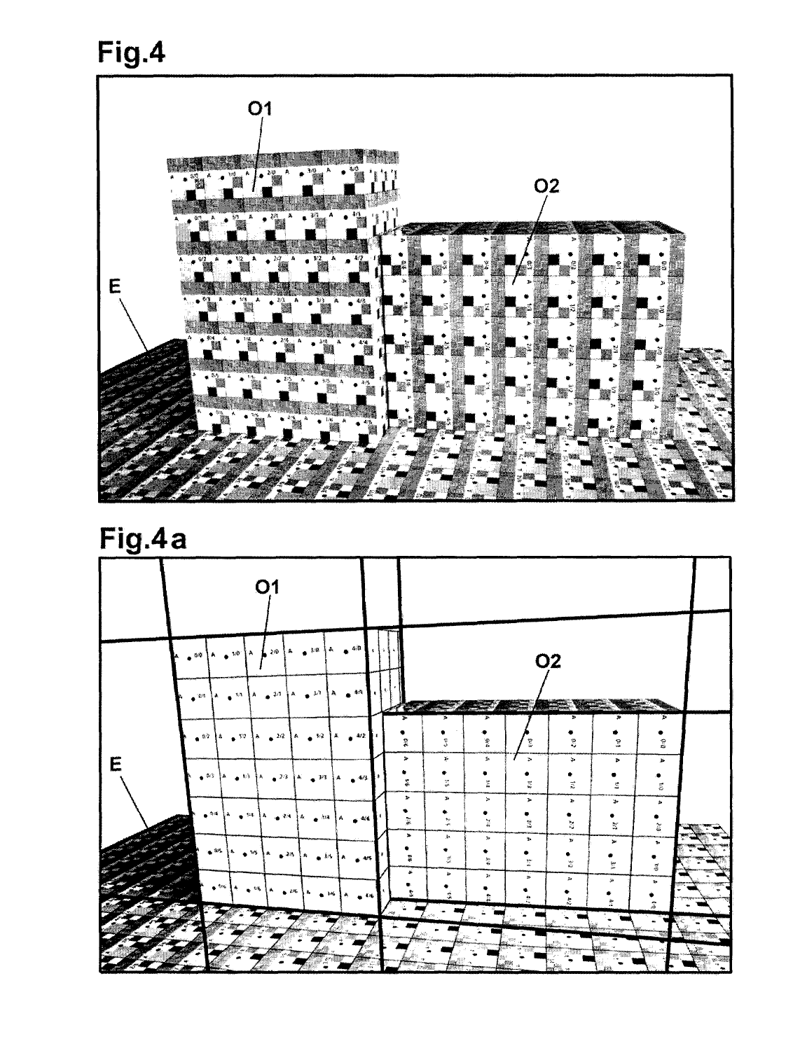

FIG. 4/4a the image of an arrangement provided with test charts of two objects standing upright on one plane, arranged at an angle to one another with a perspective modification of camera 1 in two planes without the correction according to the invention;

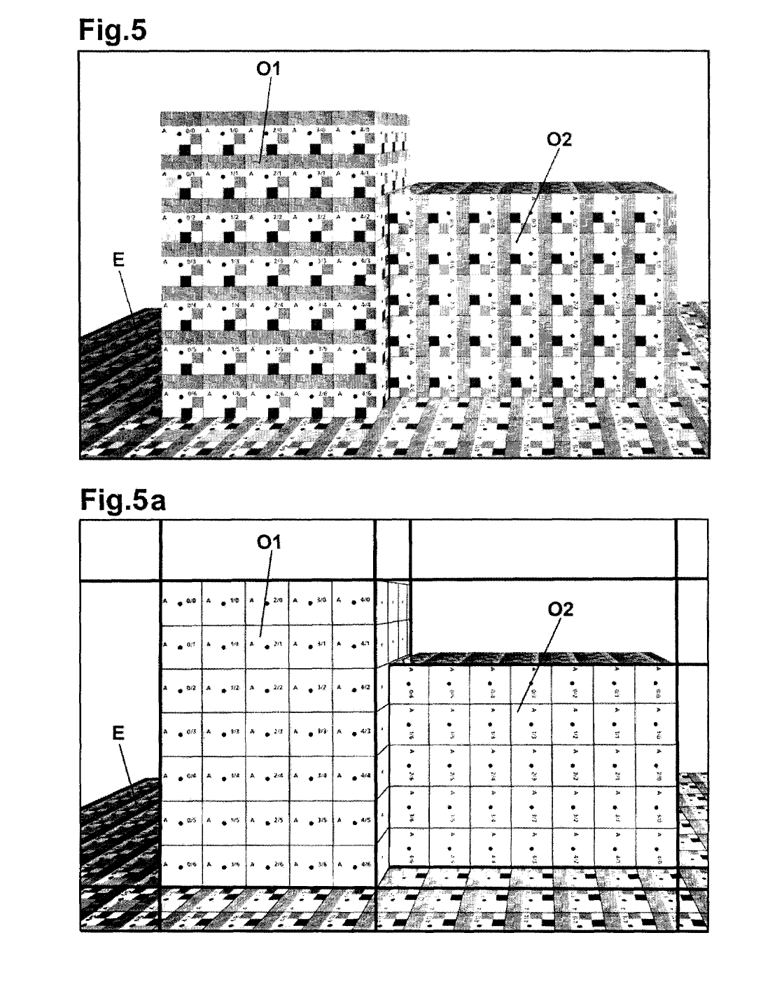

FIG. 5/5a the illustration shown in FIG. 4/4a after correction with the correction method according to the invention; and

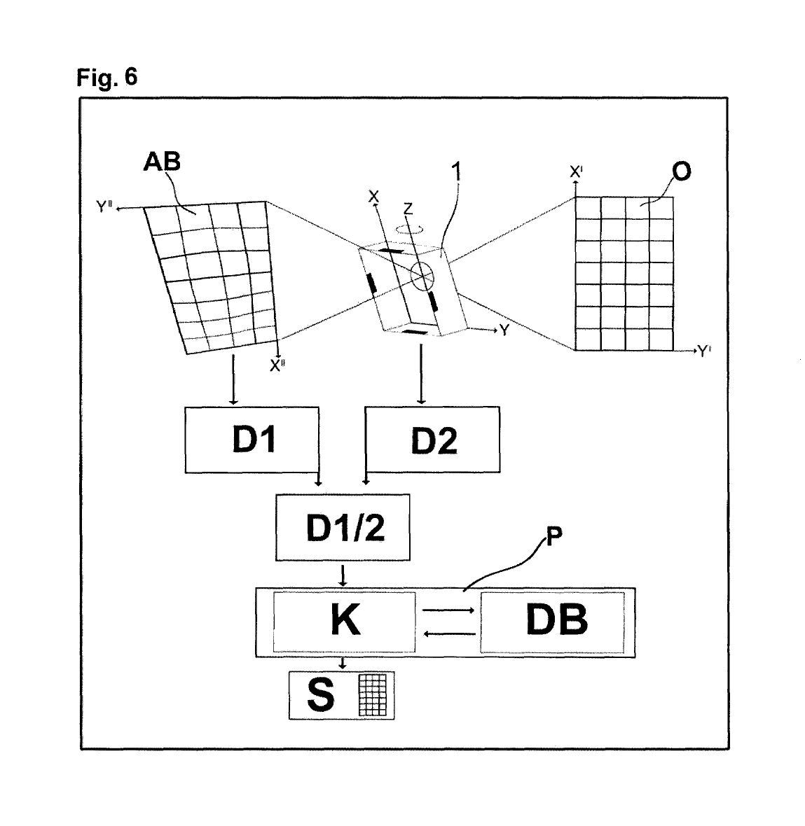

FIG. 6 a schematic flow chart for explaining the method according to the invention.

FIG. 1 shows schematically a camera 1 with a number of angular position sensors 2, 4, 6, 8. The oppositely situated angular sensors 2, 4 or 6, 8 located diametrically about the optical axis X form in each case a pair of angular sensors which form one unit in order to determine the respective angular positional deviation of the camera 1. With rotation of the camera 1 about the optical axis X an angular displacement arises between the actual horizontal H and the horizontal of the camera. In other words a top edge O of a building G illustrated schematically in FIG. 1 is no longer parallel to the upper side and underside of the image plane of the camera. The angular sensors 2, 4 compare their respective measuring signals respectively. Where these are identical, the camera is within the horizontal straight lines, i.e. the upper side and underside of the camera 2 run plane-parallel to the actual horizontal H. With a rotation about the optical axis X the two sensors 2, 4 are no longer at the same height. From the deviations of the two measuring signals of the sensors 2, 4 with respect to one another, the angular position of the camera relative to the horizontal H can be calculated (horizontal error position).

With a swivel movement about the Y axis the camera is swivelled from the vertical alignment of the image plane illustrated in FIG. 1, i.e. the alignment of the image plane in the Y-Z plane. The optical axis X then no longer runs parallel to the horizontal plane H. The two sensors 2, 4 arranged at the height of the optical axis X are not modified with regard to their output signals by this swivel movement. However, the position of the angular sensors 6, 8 relative to one another is changed. They are positioned exactly one above the other with vertical alignment of the image plane (cf. FIG. 1). When camera 1 is swivelled about the Y axis, sensors 6, 8 produce a signal which can be converted as an angular position of the optical axis X relative to the horizontal H.

With a swivel movement about the Z axis the signals output from the sensors 2 to 4 remain unchanged. A swivel movement of this nature has an effect on the perspective representation which can also lead to a deformation and can be corrected by calibration of the camera. To do this the camera becomes parallel to the front side of the G which is schematically illustrated in FIG. 1. In other words that position of the camera 1 relative to the building G is taken up, which is schematically illustrated in FIG. 1. Then the user operates a signal transmitter which indicates the calibration to the camera. If the user now wants to record the building obliquely, i.e. the camera is swivelled about the Z axis so that the optical axis X no longer meets—as shown in FIG. 1—at right angles on the planar side area of the building, when the camera is released, i.e. on producing the image data, the swivel movement of the camera about the Z axis or the data representing this movement which has occurred since the calibration is written into the camera memory. This swivel movement is for example determined based on acceleration sensors.

A comparison of FIGS. 2/2a, 3/3a, 4/4a and 5/5a explains the effect of the device according to the invention and of the inventive method used in it. With this method for the correction of perspective deformation in an optical system, the image data, which describe an image projected by the lens system, are corrected with correction data and the image data thus corrected are output for the display of a corrected image. With the invention here the angular position of the lens system is acquired with angular positional data reproducing the angular position at the time of the generation of the image data and angular position correction data are determined with the angular positional data thus found, with which the image data are corrected in order to be able to output an image corrected for an optical deformation based on the thus corrected image data.

With the method according to the invention the angular position data reproducing the angular position of the lens system at the time of the generation of the image data are written together with the image data into a common file. The file is sent to a server which manages the angular position correction data, i.e. a central computer, which normally accesses the data base with the angular position correction data. Here, the image data are corrected and passed back to the sender of the image data for the display of the corrected image, preferably automated. In this way the method according to the invention in its preferred embodiment provides the possibility of correcting image data from different senders on a single server within the scope of a central service and automatically returning them to the sender.

FIGS. 2 and 3 demonstrate the success of the method according to the invention. In FIG. 2 there are drooping lines and incorrect proportions. Compared with this, lines actually standing at right angles to one another are illustrated in the image produced with corrected image data (FIG. 3) at right angles to one another. An illustration of the two objects O1 and O2 is produced with true proportions standing upright on a plane E and arranged offset to one another.

FIG. 6 illustrates the progression in the correction of image data of an object O, which is shown with its real contours to the right next to the schematically illustrated camera 1. To the left of the camera 1 the object O is shown in the imaging plane, i.e. the image AB of the object O which has been saved after recording by an obliquely located camera on the imaging plane and is represented by the image data. It is shown that on the imaging plane the contours of the object O are deformed. In the central section of the image AB deformation of the orthogonal lines of the object A can be seen which has been caused by errors in the object lens.

The image data for image AB, i.e. that data which are saved by the sensor for the acquisition of the image information, are stored in a file. In addition to the pixel information from the sensor an EXIF file contains information about the recording format as well as the focal length and the aperture of the object recorded during recording. Furthermore, time information about the image, e.g. time of recording, has been saved. Also an incremental number has been issued for each image. This file is labelled with D1 in FIG. 4. Furthermore, measurement data from the angular sensors are written to a file D2. Also, the time information as well as the incremental numbering of the corresponding image is written into this file D2. Accordingly, for each image the image data is saved simultaneously in the file D1 along with the angular position data in file D2 as well as in both files, which facilitates synchronisation of the two data records for the corresponding image, such as for example the time information or the incremental numbering of the individual images.

The data records of the two files D1 and D2 are synchronised for an image, i.e. assigned to one another, so that for each image of the object O the image data and also the angular position data are available assigned to one another. The file produced here is labelled D1/2 in FIG. 6.

The data records from the file D1/2 are passed to the correction calculation K. This correction takes place in a processor P, to which for example the data D1/2 can be passed via the data line L. The processor P accesses a data base DB, which contains both angular position correction data for a large number of conceivable angular positions of the optical system as well as correction data for individual object lenses, i.e. “profiles” of the optical errors in the object lenses used. The data base can contain all conceivable object lenses with their errors or at least those usually found in professional photography. The corresponding profiles are normally produced in that a correction data record is produced for the optical error of a certain object lens by comparison of a digitised template with the image of the template found with the corresponding object lens. This data record can take into account both the distortion of the object lens as well as the vignetting of the object lens and other imaging errors. A possible method for the generation of appropriate profiles is described in DE 101 26 546.

In the processor P first the profile for the appropriate object lens is read out of the data base DB based on the information about the object lens used which is written in the file D1/2. Then a correction of the optical errors of the lens system for the imaging data in the file D1/2 occurs. These data corrected for lens errors are then perspectively corrected. Here, suitable angular position correction data are read from the data base DB using the angular position data contained in the file D1/2. A correction of the optically corrected image data is realised with these angular position correction data. The image, perspectively corrected for imaging errors in the lens system, is written to a storage device S as a corrected image KB.

With the method according to the invention any optical errors can be corrected centrally in the processor P. This can be operated by an operator for any number of photographers or users who send the files D1/2 or the files D1 and D2 respectively to the operator who produces the corrected image KB as a service and passes the information representing the corrected image KB to the individual users. Apart from the correction of imaging errors in the lens system and the correction of optical deformation, incorrect horizontal positions can also be corrected.

1. Method for the correction of perspective deformation in a lens system (1) in which image data, which describe an image (AB) projected through the lens system (1), are corrected with correction data and the image data (KB) corrected in this way are output for the display of a corrected image,
characterised in that,
the angular position of the lens system (1) on producing the image data acquires reproducing angular position data, a record of angular position correction data, which match the angular position data, are read out of a data base (IDB), in which a large number of data records have been saved for different angular positions of the lens system (1), and the image data are corrected with the determined angular position correction data.

2. Method according to claim 1, characterised in that the record of matching angular position correction data is selected based on angular position data which are representative of the rotation of the lens system (1) about its optical axis (X) and representative of the rotation of the lens system (1) about an axis (Y) extending at right angles to the optical axis (X) and extending horizontally with vertical alignment of the lens system (1).

3. Method according to claim 1 or 2, characterised in that the record of matching angular position correction data is selected based on angular position data which are representative of the rotation of the lens system (1) about a vertical axis (Z).

4. Method according to claim 3, characterised in that the angular position data are obtained in that the lens system (1) is initially arranged with its optical axis (X) at right angles to a planar surface of an object (G) to be imaged and the rotation about the vertical axis occurring during the transfer of the lens system (1) from this calibration position into the position taken up by the lens system (1) during the generation of the image data is determined by at least one sensor fitted to the lens system (1).

5. Method according to claim 4, characterised in that the rotation of the lens system (1) about the vertical axis (Z) is determined with at least one acceleration sensor.

6. Method according to one of the aforementioned claims, characterised in that the angular position correction data are read out of a data base (DB) in which conceivable angular positions of the lens system (1) about the three axes (X, Y, Z) of a Cartesian co-ordinate system are in each case saved at intervals.

7. Method according to one of the aforementioned claims, characterised in that the angular position of the lens system (1) for the generation of the image data together with the image data are written into a common file (D1/2) and that the file (D1/2) is sent to a server (P) which manages the angular position correction where it is corrected and returned to the sender for the display of a corrected image (KB).

8. Method according to claim 7, characterised in that after conclusion of the transfer of the angular position data of the lens system (1) and of EXIF data assigned by the optical system to the server, the corresponding image data corrections are transferred from the server to the sender.

9. Method according to one of the aforementioned claims, characterised in that the user can individually access the angular position correction data and apply each of the three angular positions of the X, Y and Z axes manually to the image data according to design viewpoints and process in the processor (P) the version relevant to the user via previews with slight resolution. Since the perspective correction and the designing influence on the perspective is defined via the imaging plane (AB), the term of a “virtual standard” is introduced here.
